(19) United States
(12) Patent Application Publication
(10) Pub. No.: US 2005/0026521 A1
(43) Pub. Date: Feb. 3, 2005

(54) Tennis ball

(76) Inventor: Alan John Brasier, Stonehouse (GB)

Correspondence Address: Jeffery E. Bacon, Legal Department, M-495, PO Box 1926, Spartanburg, SC, 29304, US

(21) Appl. No.: 10/909,617

(22) Filed: Aug. 2, 2004

Related U.S. Application Data
(62) Division of application No. 09/397,618, filed on Sep. 16, 1999, now abandoned.

(30) Foreign Application Priority Data
Sep. 17, 1998 (GB) 9820165.0
Sep. 10, 1999 (EP) 99307183.6

(51) Int. Cl. A63B 41/10; A63B 41/08; A63B 41/04; A63B 41/02; A63B 41/00; A63B 39/08; A63B 39/06; A63B 39/00; D04H 5/02; D04H 3/10; D04H 1/46; B32B 5/26

(52) U.S. Cl. 442/35; 473/606; 442/402

(57) ABSTRACT

According to a first aspect of the present invention there is provided a tennis ball having a hollow resilient core to which a needlefelt covering is adhered. The needlefelt comprises an entanglement of fibers produced by needling a fiber batt in a range of angles including a plurality of angles which are non-perpendicular to the plane of the batt, and cutting or otherwise shaping the needlefelt to form a blank adapted at least partially to cover a ball. The needlefelt includes a scrim material therein.

### CROSS-REFERENCE TO RELATED APPLICATIONS

This application is a provisional of prior co-pending U.S. application Ser. No. 09/397,618, filed on Sep. 16, 1999, and United Kingdom Application 9620165.0, filed on Sep. 17, 1998, the contents of all of which are incorporated by reference herein in their entirety.

### BACKGROUND

This invention relates to a tennis ball, and in particular, a tennis ball having a non-woven fabric covering.

Traditionally, tennis balls have been covered with a felted textile material having a surface predominantly composed of wool fibers and based on a woven scrim or substrate. During the process of finishing the felted textile material, the scale structure of the wool fibers is utilized to produce the characteristic felted surface appearance of the ball.

Following the introduction of needlefelting machines, attempts have been made to produce and utilize needlefelts (felts composed of non-woven fabrics and produced by needlefelting machines) for covering tennis balls. However, needlefelts lack the flexibility that is characteristic of woven fabrics, and consequently when balls are covered with shaped blanks of needlefelt, the seams of the covering are liable to be defective due to puckering of the blanks. Also, the so-covered balls tend to feel hard when hit, exhibit poor flight characteristics, and have poor wear resistance. These adverse properties arise from the smoother surface and greater consolidation of non-woven felts in comparison to woven felts.

Attempts have been made to overcome the above-discussed defects of conventional needlefelted ball coverings, for example by modifying needling density (needle penetrations per unit area of web), or by incorporating a felt-backing scrim of greater flexibility; such attempts have not been successful. In a recent attempt to increase fiber entanglement in the finished felt, a percentage of wool fiber has been incorporated into the fiber blend prior to needlefelting, and the needlefelted fabric has been milled in a manner similar to the milling of woven felts. However, the non-woven fabrics that resulted from these procedures still failed to replicate the desirable characteristics of good-quality woven ball-covering felts.

A comparative study of the cross-sectional characteristics or microstructure of traditionally woven tennis ball felts and non-woven felts produced by needlefelting machines showed that fibers in woven felt are predominantly anchored in the base woven structure but are distributed in generally random directions throughout the surface pad of the felt, thus producing a high level of fiber intersections for a given density of felt. Also, the fiber density declines from the scrim (basecloth or backing) of the felt towards the opposite surface (normally the outer surface). The base structure retains a woven characteristic, and has a significantly greater fiber density than the outer surface. A typical woven ball-covering felt has a fiber density of 300 milligrams per milliliter at its base, diminishing to about 150 milligrams per milliliter towards the opposite (outer) surface. These characteristics, particularly the degree of fiber entanglement per unit density, are critical to the behavior of the felt both during the ball-covering process and on the ball in play (i.e. in use). Conventional needlefelting techniques redistribute a proportion of the fibers laid predominantly horizontally during the cross-lapping process into a predominantly vertical configuration, the fibers needled to verticality intersecting those not impacted by the needles at or close to right angles. Also, the fiber density (excluding any scrim material) can be seen to be nearly consistent throughout the thickness of the felt. From these observations it becomes apparent that the ratio of fiber intersections or degree of fiber entanglement is much lower in needlefelt than in woven felt for a given density of material. Thus, in order to achieve acceptable abrasion resistance and wear resistance characteristics in a ball that is covered in a needlefelt by means of giving the needlefelt a level of fiber entanglement that is comparable to that in a woven ball-covering felt, it is necessary to apply a high needling density (number of needle penetrations per unit of web area). High needling density renders the resultant needlefelt significantly less flexible than woven ball-covering felt, thus making the ball-covering process more difficult and more prone to defects. Balls covered with highly needled felt feel harder when hit than balls covered in woven felt, and generally fly faster due to the needlefelt surface being smoother and more consolidated than the surface of a woven felt. Such deficiencies may not be particularly significant for recreational use of tennis balls, but the defects in ball characteristics renders such balls unacceptable for use in professional tennis and in championship-level tennis matches.

From the facts detailed above, it can be concluded that felted ball coverings produced using conventional neddlefelting techniques cannot replicate the density and wear characteristics equivalent to woven ball-covering felts and simultaneously provide the performance characteristics required of good-quality tennis balls (e.g. tennis balls of championship standard).

### SUMMARY OF THE INVENTION

It has now been discovered that a needlefelt produced by a needlefelting machine having a needleboard which is curved or otherwise shaped to ensure fiber entanglement in a range of angles (transverse to the plane of the felt web) exhibits surprisingly good characteristics of both wear and covering capabilities, and is particularly suitable for tennis ball coverings.

According to a first aspect of the present invention there is provided a tennis ball having a hollow resilient core to which a needlefelt covering is adhered. The needlefelt comprises an entanglement of fibers produced by needling a fiber batt in a range of angles including a plurality of angles which are non-perpendicular to the plane of the batt, and cutting or otherwise shaping the needlefelt to form a blank adapted at least partially to cover a ball.

According to a second aspect of the present invention, the needlefelt includes a scrim material therein.

### BRIEF DESCRIPTION OF THE DRAWINGS

Embodiments of the invention will now be described by way of example with reference to the accompanying drawings wherein

FIG. 1 is a schematic representation of fiber entanglement in the needlefelt applied to ball covering in accordance with the present;

FIG. 2 is a schematic representation of the needle paths following by the needle in the needlefelt applied to ball covering in accordance with the present invention;

FIG. 3 is a schematic representation of a needlefelting machine and process for the production of a ball-covering needlefelt in accordance with the present invention;

FIG. 4 is a schematic representation of fiber entanglement in a conventional needlefelt; and

FIG. 5. invention is a schematic representation of the needle paths followed by the needles in conventional needling in a conventional needlefelt

### DESCRIPTION OF THE PREFERRED EMBODIMENTS

The present invention comprises a tennis ball having a resilient hollow ball at least partially covered by a needlefelt. The needlefelt comprises an entanglement of fibers produced by needling a fiber batt in a range of angles including a plurality of angles which are non-perpendicular to the plane of the batt. The needlefelt can include a scrim material therein.

To make a tennis ball covered by the needlefelt obtained by cutting suitably shaped blanks are cut from the needlefelt, and then gluing the blanks on to a ball core constituted by a resilient hollow rubber sphere of appropriate dimensions. Such blanks may be the “figure-eight” blanks traditionally used in pairs for forming the covering of a tennis ball. The scrim provides a smooth backing surface enabling good adhesion between the needlefelt and the hollow rubber core of the ball.

References in this specification to “tennis ball(s)” are to be taken as comprising references to analogous balls, i.e. to balls for games other than tennis but which are resilient hollow balls or otherwise structurally and functionally analogous to tennis balls, whether or not such analogous balls are interchangeable with tennis balls, and to felt-covered balls in general. For the meaning of textile-related terms as used in this specification, attention is directed to the definitions in the reference book “Textile Terms and Definitions” (Eighth Edition) published in 1986 by The Textile Institute (of the United Kingdom).

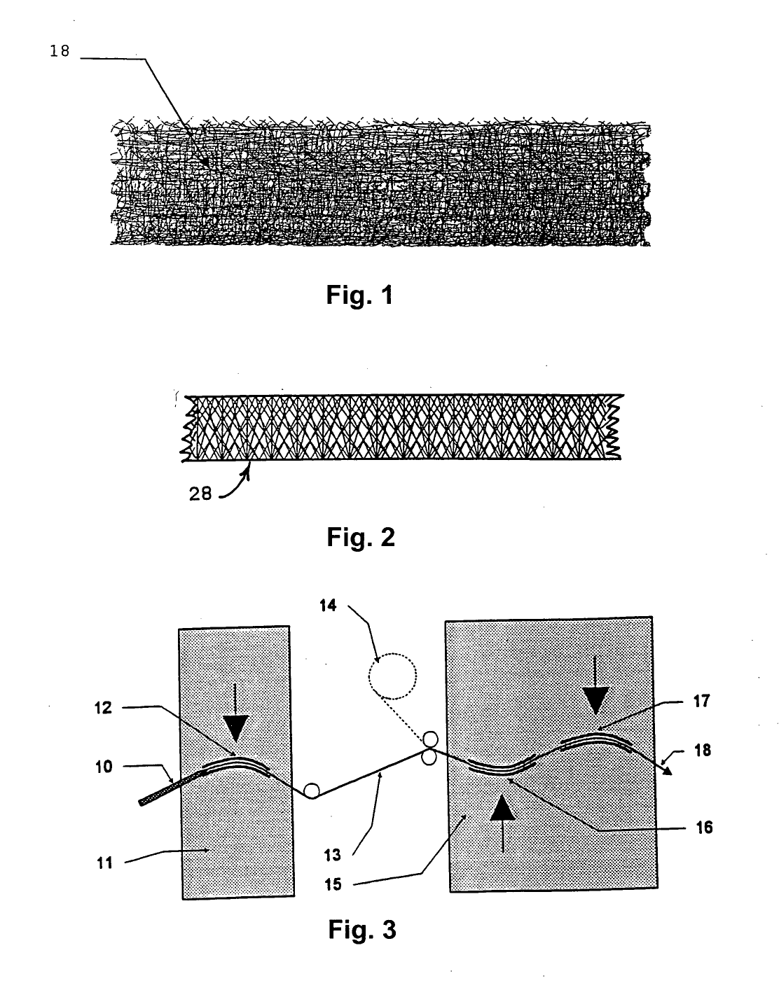

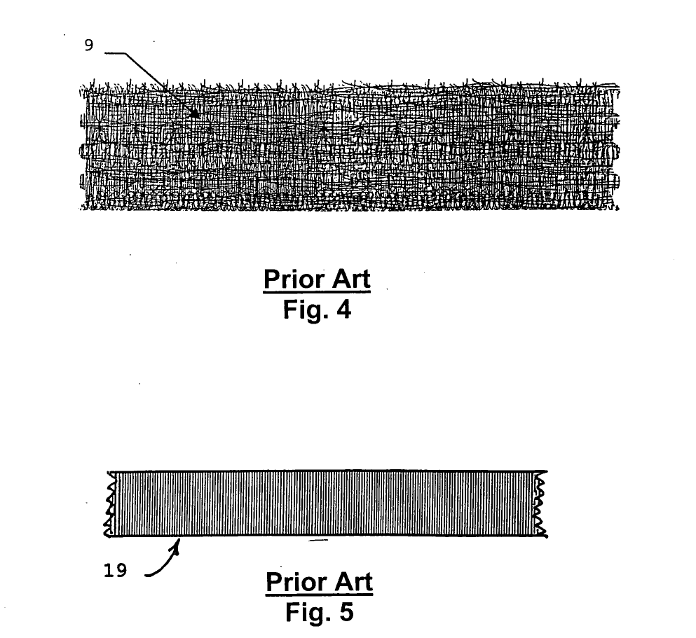

Referring now to FIG. 1, there is shown a schematic representation of the needlefelt applied to ball covering in accordance with the present. FIG. 2 schematically depicts the needlepaths 28 of needles used to produce the needlefelt 18 as shown in FIG. 5 with highly entangled fibers. Such needlepaths are produced by the needlefelting machinery about to be described with reference to FIG. 3. Such needlefelting machines are available from the Austrian Company Textiles Maschinenfabrik Dr E. Ferher AG and are known in the Trade as machines incorporating “Ferhrer H1 Technology” (see published British Patent Applications GB2306519-A, GB2310221-A, GB2312220-A, GB2315281-A, & GB2316957-A). However, these novel needle felting machines and techniques have never previously been proposed for production of a non-woven fabric having characteristics suitable to be used as a tennis ball covering.

Referring now to FIG. 3. To produce the needlefelt 18 of FIG. 1, an appropriate blend of fibers, either dyed or undyed, is carded and cross-lapped to form a fiber batt 10 (FIG. 3) as a starting material for the needlefelting processes to follow. The batt 10 weighs between 350 grams per square meter and 850 grams per square meter depending on the weight required for the finished product. The fibers of the batt 10 could be composed of a mixture of wool and polyamide fibers, but other fibers could be incorporated or substituted as necessary or desirable.

The batt 10 is then passed through a pre-needling needlefelting machine 11 wherein the batt is curved while being needled such that the needles penetrate the batt in a range of angles, including a plurality of angles which are non-perpendicular to the surface of the batt. The machine 11 has a correspondingly curved needleboard 12 containing about 5000 needles disposed in a down-punch configuration (i.e. the needles are driven into the batt from above). The pre-needling machine 11 is advantageously of the type described in GB2315281-A, and as sold under the Trade Name “Fehrer H1 Technology” by the Fehrer Company of Austria.

The shape and size of the needles selected for use in the pre-needling machine 11 would depend on the results required. These needles are preferably three-inch, 40-gauge needles with regular barbs. Draft (reduction of linear density by drawing or longitudinal stretching), needle penetration depth and penetration density (number of needle penetrations per unit area of batt) are varied according to product requirements. For a tennis ball covering of good quality it is preferred to use a draft of about 15% and to provide a penetration depth of about 10 millimeters at about 80 needle penetrations per square centimeter of batt.

The pre-needled batt of fibers 13 as delivered from the pre-needling machine 11, together with an appropriate scrim (backing fabric) 14, are passed through a finish needling machine 15 with the width and length of the batt 13 being generally horizontal. The scrim 14 is preferably a polyester or polyamide warp knit with a weight of about 75 grammes per square meter. Where the needlefelt incorporates the scrim 14, the first of said two needleboards is preferably disposed to needle the layered combination of batt and scrim from the side opposite to the scrim.

The machine 15 has two needleboards 16 & 17, each needleboard of the needleboards 16 & 17 containing approximately 5000 needles, the first needleboard 16 being disposed in up-punch configuration and the second needleboard 17 being disposed in down-punch configuration. (“Up-punch” refers to the needles being driven into the batt from below, and “down-punch” refers to the needles being driven into the batt from above). Each of the needleboards 16 & 17 is curved in a longitudinal plane, i.e. a plane which extends in the direction of batt travel through the needling machine 15 and which is also vertical to the lateral extent of the generally horizontal batt 13 (e.g. as described in GB2306519-A & GB2312220-A), the batt 13 (and scrim 14) being correspondingly curved during needling by the respective needleboards 16 & 17. Such curvature results in the batt 13 and scrim 14 being needled in a range of angles, including a plurality of angles which are non-vertical to the surface of the batt, thereby to produce a needlefelt in which the fibers are highly entangled (as depicted in FIG. 2).

At the upstream or input end of the needling machine 15, the scrim 14 is in-fed to lie along and above the fiber batt 13. Thus the first (up-punch) needleboard 16 of the finish needling machine 15 will needle fibers from the fiber batt 13 upwardly through the scrim 14 while the second (down-punch) needleboard 17 will needle fibers back down through the scrim 14 into the fiber batt 13. By selectively altering the punch density and the depth of needle penetration by the second needleboard 17 it is possible to controllably alter the fiber density through the thickness of the finished needlefelt 18.

The needles selected for use in the finish needling machine 15 would depend on the results required. These needles are preferably 3-inch, 40-gauge needles with regular barbs. Draft, needle penetration depth and penetration density can be varied according to product requirements; by suitably varying these parameters it is possible to alter the flexing characteristics, surface appearance and wear characteristics of the product. For tennis ball coverings of a good quality it has been found that a penetration of 14 millimeters at down-punch and a penetration of 10 millimeters at up-punch with a punch density of 80 penetrations per square centimeter without drafting (i.e. without reducing linear density by drawing or longitudinal stretching) can produce good results with regard to meeting the performance characteristics required for championship tennis. Reference to FIG. 2 will show the reason for this improvement in properties, namely the entanglement of fibers at various different angles due to the several different needle penetration angles arising from the imposition of longitudinal curvature on the batt as it is needled (see FIG. 6 of GB2310221-A, & FIG. 1 of GB2312220-A).

The needlefelt tennis ball covering material so produced may optionally be subjected to further processing. For example, a woolen milling process can, if required, be used to enhance the felt characteristics, particularly in respect of appearance and some aspects of wear. Additionally, the needlefelt may be dyed at this stage and dried. A shearing or cropping process may also be deemed appropriate.

The needling process carried out on longitudinally curved batt produces fiber entanglement by moving fibers through the thickness of the felt at angles other than the conventional 90 degrees to the felt surface thus giving increased fiber to fiber contact at lower punching densities. This allows the manufacture of a needlefelt having high levels of fiber entanglement but without excessive consolidation. By using such needlefelting technology and controlling the depth of needle penetration it is possible to vary and control the density of the felt through its thickness.

The preferred needling machinery for producing ball-covering felts is schematically depicted in FIG. 3, but modified arrangements may be utilized. For example, two separate needling machines (not shown) may be utilized in tandem (with suitable synchronization of batt movement). Alternatively, a needling machine with only a single needleboard may be utilized. The pre-needling machine may be integrated with the needling machine, or omitted from the needlefelting process.

In contrast, FIG. 4 is a schematic cross-section through a conventional needlefelt 9, the cross-section being taken in a vertical longitudinal plane. The needlefelt 9 is formed from a web or batt of non-woven fibers, the batt being of indefinite length from left to right as viewed in FIG. 4 (which depicts a short piece of the batt). The vertical lines shown in FIG. 5 (19) depict the needle paths followed by the needles during the conventional needlefelting process which provoke change of orientation of some of the fibers from initially horizontal alignments to vertical alignment (i.e. at right angles to the plane of the batt). It is to be particularly noted that the fibers in this conventional needlefelt 9 are entangled to a minimal extent.

While certain modifications and variations of the preferred embodiments have been described above, the invention is not restricted thereto, and other modifications and variations can be adopted without departing from the scope of the invention as defined in the appended claims.

1. A tennis ball comprising a resilient hollow core at least partially covered with a needlefelt having a surface and an entanglement of fibers in a range of angles including a plurality of angles which are non-perpendicular with respect to the surface.

2. The tennis ball according to claim 1, wherein the needlefelt includes a scrim.

3. A tennis ball formed by securing a needlefelt to a resilient hollow core, wherein said needlefelt is characterized in that it comprises an entanglement of fibers formed by the needlefelting of a fiber batt passed through a needlefelting machine having at least one needleboard providing needles to penetrate said batt in a range of angles including a plurality of angles which are non-perpendicular with respect to the surface of the batt, and in that said needlefelt is cut or otherwise shaped to form a blank adapted at least partially to cover a ball.

4. The tennis ball according to claim 3, wherein said needles are barbed.

5. The tennis ball according to claim 3, wherein the batt is moved longitudinally as a step in the needling process, characterized in that the batt is curved in a longitudinal direction while being needled.

6. The tennis ball according to claim 5, wherein during needling of the batt in the needlefelting machine the batt is curved in the direction of its travel through the needlefelting machine.

7. A needlefelt as claimed in 6, characterized in that the needleboard is correspondingly curved.

8. The tennis ball according to claim 3, wherein the needlefelting machine comprises two needleboards at respective locations which are mutually displaced along the direction of travel of the batt through the needlefelting machine.

9. The tennis ball according to claim 8, wherein that the two needleboards are respectively disposed to needle the batt from mutually opposite sides of the batt.

10. The tennis ball according to claim 8, wherein the needlefelt incorporates a scrim, characterized in that the first of said two needleboards in the direction of travel of the batt through the needlefelting machine is disposed to needle the layered combination of batt and scrim from the side opposite to the scrim.

11. The tennis ball according to claim 3, wherein prior to being needled, the batt is subjected to a preliminary consolidation and fiber entanglement in a pre-needling machine.

12. The tennis ball according to claim 11, wherein the batt is curved in its direction of travel through the pre-needling machine while being partially consolidated in the pre-needling machine.
